(19) United States
(12) Patent Application Publication
(10) Pub. No.: US 2026/0254712 A1
(43) Pub. Date: Aug. 27, 2026

(54) EXPOSURE FUNCTION SUBSCRIPTION AND NOTIFICATION PROCESSING

(71) Applicant: T-Mobile Innovations LLC, Overland Park, KS (US)

(72) Inventors: Zenaida CANLAS-FACTORA, Renton, WA (US); Paul Marvin CHY, Snohomish, WA (US)

(21) Appl. No.: 19/061,158

(22) Filed: Feb. 24, 2025

(51) Int. Cl. H04L 41/0686; G06F 16/955; H04L 41/0631

(52) U.S. Cl. CPC H04L 41/0686; G06F 16/955; H04L 41/0631

(57) ABSTRACT

Methods and systems enhance exposure function subscription and notification processes. Embodiments provided herein trigger a notification from an exposure function to an application function (AF) having a subscription to services offered through the exposure function. The notification utilizes a first of multiple callback URLs corresponding to the subscription. Responsive to an error code, embodiments provided herein trigger a second notification from the exposure function to the AF using a second of the multiple callback URLs.

### TECHNICAL BACKGROUND

As wireless networks evolve and grow, there are ongoing challenges in communicating data across different types of networks. For example, a wireless network may include one or more access nodes, such as base stations, including, for example, evolved NodeBs (eNodeBs or eNBs) and next generation NodeBs (gNodeBs or gNBs) for providing wireless voice and data service to wireless devices in various coverage areas of the one or more access nodes. As wireless technology continues to improve, various different iterations of radio access technologies (RATs) may be deployed within a single wireless network. Such heterogeneous wireless networks can include newer 5G and millimeter wave (mm-wave) networks, as well as 4G long-term evolution (LTE) access nodes.

5G networks include a core network utilizing a service based architecture (SBA) with multiple network functions (NFs). A network exposure function (NEF) is an NF that acts as a secure gateway to allow external and internal application functions (AFs) and services to access and interact with network capabilities. The NEF requires a callback uniform resource locator (URL) as part of a subscription from any AF. Similarly, with respect to 4G networks, a service capability exposure function (SCEF) is provided to securely expose servers and capabilities provided by third generation partnership (3GPP) network interfaces. The SCEF interacts with the AFs in 4G LTE networks in a similar manner to the NEF in 5G new radio (NR) networks.

The callback URL is used by the exposure functions (NEF and/or SCEF) to send notifications to the AF for events generated by the NFs. For example, in the 5G NR environment, when an event includes a wireless device or user equipment (UE) moving from one cell to another, an access and mobility function (AMF) triggers this event and sends it to the NEF. Alternatively, for a bearer deletion event, the event is forwarded to the NEF from a policy control function (PCF). These sample events are handled by the NEF. The NEF notifies the AF of the event using a callback URL provided during the subscription process between the AF and the NEF. In a best case scenario, the NEF can send the notification to the callback URL without any issue. The AF will then act accordingly based on business logic once successful notification is received. If for some reason, the NEF is not able to reach the AF, notification is dropped. The process of utilizing a single callback URL for subscriptions has multiple limitations including, for example, geographical limitations, security limitations, and capacity limitations. Accordingly, a solution is needed for providing an improved notification procedure without such limitations.

### OVERVIEW

Exemplary embodiments provided herein include a method for exposure function subscription and notification. In embodiments provided herein, the method includes receiving at an exposure function, a subscription request from an application function (AF), the subscription request including multiple callback uniform resource locators (URLs) associated with multiple servers. The method additionally includes receiving, at the exposure function, an event trigger associated with an event related to the subscription and sending a notification from the exposure function to the AF of the event using a first of the multiple callback URLs. The method further includes receiving an error code in response to the notification and sending a notification from the exposure function to the AF using a second of the multiple callback URLs in response to receipt of the error code.

Embodiments disclosed herein further include a system for exposure function subscription and notification. The system includes a memory storing data and instructions and at least one processor executing the stored instructions to perform multiple operations. The operations include storing, at an exposure function, a subscription from an AF, the subscription including multiple callback URLs associated with multiple servers. The operations additionally include triggering a notification from the exposure function to the AF of an event, the notification using a first of the multiple URLs. Responsive to receipt of an error code, the operations include sending a notification from the exposure function to the AF using a second of the multiple URLs.

In a further embodiment, a non-transitory computer-readable medium stores instructions executed by a processor to perform multiple operations. The operations include triggering a notification from an exposure function to an AF having a subscription to services offered through the exposure function, the notification using a first of multiple callback URLs corresponding to the subscription. The operations additionally include triggering a notification from the exposure function to the AF using a second of the multiple callback URLs responsive to an error code.

Further embodiments include NEFs, SCEFs, AFs, and processing nodes performing the operations described above.

### BRIEF DESCRIPTION OF THE DRAWINGS

FIG. 1 depicts an exemplary environment for an exposure function subscription and notification system in accordance with an embodiment.

FIG. 2 depicts an exposure function subscription and notification system in accordance with an embodiment.

FIG. 3 depicts an exposure function subscription and notification system operating within a core network in accordance with an embodiment.

FIG. 4 depicts an exposure function subscription and notification system operating within a core network in accordance with another embodiment.

FIG. 5 depicts an exemplary method for exposure function subscription and notification in accordance with an embodiment.

FIG. 6 depicts a further exemplary method for exposure function subscription and notification in accordance with an embodiment.

FIG. 7 depicts an exemplary end-to-end method for method for exposure function subscription and notification in accordance with an embodiment.

### DETAILED DESCRIPTION

In embodiments disclosed herein, functionality for an exposure function subscription and notification system is provided. Existing subscription processes involve transmission of a single callback URL corresponding to a single application function (AF) server from an AF to the exposure function (network exposure function (NEF) or service capability exposure function (SCEF)). Existing notification processes involve utilizing the single callback URL provided. The existing process creates a single point of failure such that if the callback URL becomes unavailable due to server issues, network problems, maintenance, or other factors, the entire communication process can be disrupted. Further, as the network grows and the number of subscriptions increases, a single server corresponding to the callback URL may not be able to handle the subscription and notification load efficiently. Additionally, a single callback URL is typically not optimized for a large number of geographical locations. Therefore, the practice of utilizing a single callback URL for notifications from an exposure function to an AF may lead to higher latency and slower performance for users who are geographically distant from the server. A further limitation is related to security risks. When relying on a single callback URL, if the callback URL or the server associated with the callback URL is compromised, unauthorized access and potential data breaches can result

Accordingly, in embodiments disclosed herein, multiple callback URLs are provided during the subscription process by the AF. Each callback URL may be configured for accessing a corresponding server of the AF. Multiple callback URLs can provide alternative secure paths, enhancing overall security. During notification processing, a first callback URL may be utilized by the exposure function to contact the AF. In some instances, the exposure function receives an error message and thus utilizes a second callback URL contained in the original subscription in order to notify the AF. In some embodiments, for example, with particularly large systems or networks, more than two callback URLs may be associated with the subscription.

Thus, to overcome this issue with the use of a single callback URL, at least one secondary callback URL is introduced in the subscription and callback notification procedures. If a primary callback URL is not available or reachable, the exposure function may attempt notification using the secondary callback URL. With this implementation, chances are increased that the AF will receive notifications related to any critical or sensitive events. The provision of multiple callback URLs offers increased redundancy and reliability. If a primary callback URL fails due to network issues, server downtime, or other unforeseen problems, a secondary URL ensures that communication remains uninterrupted. This redundancy helps to maintain continuous service availability and reliability.

Further, the provision of multiple callback URLs can assist with load balancing by distributing the load across different servers. This load balancing prevents any single server from becoming a bottleneck, thereby improving the overall performance and responsiveness of the network. Related to the load balancing is the concept of geographical distribution. By having callback URLs in different geographical locations, the exposure function can ensure decreased latency and improved performance for users in various regions. This geographical distribution helps in optimizing network efficiency and user experience.

Additionally, during subscription and notification processes, the use of multiple callback URLs can also enhance security by providing alternative paths for communication. If one URL is compromised, the system can switch to another secure URL, thereby maintaining the integrity and security of the network.

In addition to the systems and methods described herein, non-transitory computer-readable mediums may store the operations for the instructions or methods. Further, processing nodes on the network may execute the instructions or methods. The processing node may include a processor included in the NEF, SCEF, the AF, and/or a processor included in any controller node in the wireless network.

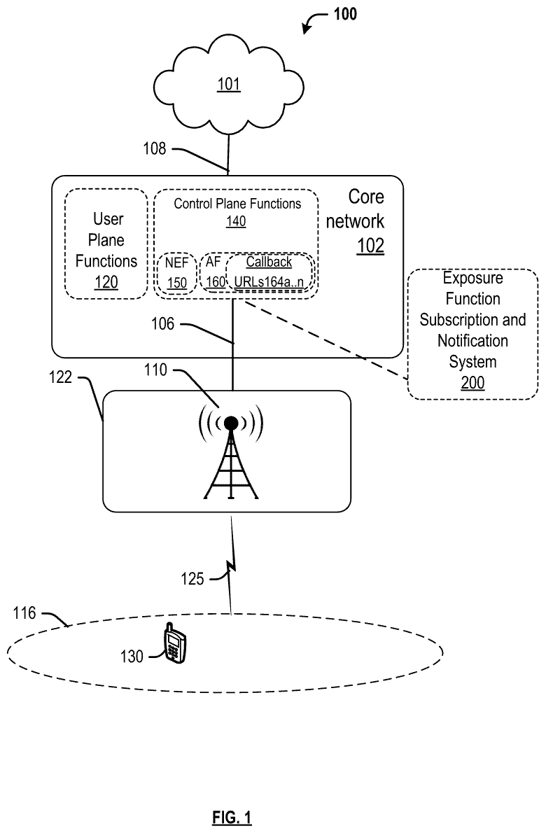

FIG. 1 depicts an exemplary environment 100 for implementing an exposure function subscription and notification system 200. Environment 100 comprises a communication network 101, core network 102, and a radio access network (RAN) 122 including at least an access node 110. Wireless device 130 is located in a coverage area 116 and communicates with the access node 110 over communication link 125. Although only one wireless device 130 is shown, it should be understood that any number of wireless devices could be included. The exposure function subscription and notification system 200 interacts with the core network 102, which includes control plane functions 140 and user plane functions 120. Specifically, in the 5G environment, the exposure function subscription and notification system 200 enhances the subscription and notification process between an NEF 150 and one or more AFs 160. Although only one AF is shown, it should be understood that multiple AFs 160 may be included. Every service or application may require its own AF.

In the illustrated environment, the core network 102 includes an SBA architecture, in which service-based interfaces may be utilized between control plane functions 140, while multiple UPFs 120 connect over point-to-point link. The UPF 120 accesses a data network, such as network 101, and performs operations such as packet routing and forwarding, packet inspection, policy enforcement for the user plane, quality of service (QoS) handling, etc. The control plane functions 140 includes the NEF 150, the AF 160 and multiple additional network functions (NFs), which are omitted for simplification.

The NEF 150 is a network function located between the core network 102 and both external and internal AFs 160. The NEF 150 is responsible for managing external open network data and external applications that want to access the internal data of the 5G core network 102 must pass through the NEF 150. The NEF 150 provides the tools to expose services and capabilities provided by 3GPP 5G network functions. The NEF 150 securely exposes the network services and capabilities to either third party applications or internal AFs 160 over an Application Programming Interface (API).

The AF 160 may include multiple AFs and each AF may include multiple application servers that interact with 5G core network control planes. Each application server may have a corresponding callback URL 164a . . . 164n. The AF 160 includes at least two of these callback URLs 164a . . . 164n in each subscription request sent to the NEF 150.

The exposure function subscription and notification system 200 is illustrated as communicating with or incorporated in the core network 102. In some embodiments, the exposure function subscription and notification system 200 may be incorporated in or in direct communication with the NEF 150. The exposure function subscription and notification system 200 may further communicate with or be partially incorporated in the AF 160.

The RAN 122 can include various access network functions and devices disposed between the core network 102 and the end-user wireless device 130. For example, the RAN 122 includes at least an access node (or base station), such as an eNodeB and/or a next generation NodeB (gNodeB) 110 communicating with an end-user wireless device 130. Further, either of core network 102 and radio access network 122 can include one or more of a local area network, a wide area network, and an internetwork (including the Internet) and be capable of communicating signals and carrying data, for example, to support voice, push-to-talk, broadcast video, and data communications by end-user wireless device 130.

Access node 110 can be any network node configured to provide communication between end-user wireless device 130 and communication network 101, including standard access nodes and/or short range, low power, small access nodes. For instance, access node 110 may include any standard access node, such as a macrocell access node, base transceiver station, or a radio base station, or the like. In embodiments further discussed herein, the access node 110 is a next generation NodeB (gNB). However, the access node 110 may include multiple co-located access nodes, such as a combination of eNodeBs and gNodeBs. Access node 110 can be a small access node including a microcell access node, a picocell access node, a femtocell access node, or the like such as a home NodeB or a home eNodeB device. Moreover, it is noted that while access node 110 and wireless device 130 are illustrated in FIG. 1, any number of access nodes and wireless devices can be implemented within environment 100.

As further described herein, by utilizing antennas, access node 110 can deploy a wireless air interface 125 using one or more frequency bands over one or more coverage areas 116. Further, the different sets of antennas can be used to implement various transmission modes or operating modes in each sector, including but not limited to multiple in multiple out (MIMO), carrier aggregation (including inter-band and intra-band carrier aggregation), and different duplexing modes including frequency division duplexing (FDD) and time division duplexing (TDD).

Wireless device 130 may be any device, system, combination of devices, or other such communication platform capable of communicating wirelessly with access node 110 using one or more frequency bands deployed therefrom. Wireless device 130 may be, for example, a mobile phone, a wireless phone, a wireless modem, a personal digital assistant (PDA), a voice over internet protocol (VoIP) phone, a voice over packet (VOP) phone, a soft phone, a home internet (HINT) device, a fixed wireless access (FWA) device as well as other types of devices or systems that can exchange audio or data via access node 110. The FWA devices may include, for example, customer premises equipment (CPE). Additionally, wireless devices have evolved to include Internet of things (IoT) devices, which describes the network of physical objects or things that are embedded with sensors, software, and other technologies for the purpose of connecting and exchanging data with other devices and systems over the Internet. The wireless device 130 can be end-user wireless devices (e.g., user equipment (UEs)) utilizing communication link 125, which may operate based on 6G, 5G new radio (NR), 4G long term evolution (LTE), or any other suitable type of radio access technology (RAT).

Communication network 101 can be a wired and/or wireless communication network, and can comprise processing nodes, routers, gateways, and physical and/or wireless data links for carrying data among various network elements, including combinations thereof, and can include a local area network a wide area network, and an internetwork (including the Internet). Communication network 101 can be capable of carrying data, for example, to support voice, push-to-talk, broadcast video, and data communications by wireless device 130. Wireless network protocols can comprise multimedia broadcast multicast services (MBMS), code division multiple access (CDMA) single-Carrier radio transmission technology(1xRTT), Global System for Mobile communications (GSM), Universal Mobile Telecommunications System (UMTS), High-Speed Packet Access (HSPA), Evolution Data Optimized (EV-DO), EV-DO rev. A, Third Generation Partnership Project Long Term Evolution (3GPP LTE), and Worldwide Interoperability for Microwave Access (WiMAX), Fourth Generation broadband cellular (4G, LTE Advanced, etc.), and Fifth Generation mobile networks or wireless systems (5G, 5G New Radio (“5G NR”), or 5G LTE). Wired network protocols that may be utilized by communication network 101 comprise Ethernet, Fast Ethernet, Gigabit Ethernet, Local Talk (such as Carrier Sense Multiple Access with Collision Avoidance), Token Ring, Fiber Distributed Data Interface (FDDI), and Asynchronous Transfer Mode (ATM). Communication network 101 can also comprise additional base stations, controller nodes, telephony switches, internet routers, network gateways, computer systems, communication links, or some other type of communication equipment, and combinations thereof.

Communication links 106 and 108 can use various communication media, such as air, space, metal, optical fiber, or some other signal propagation path-including combinations thereof. Communication link 106 can be wired or wireless and use various communication protocols such as Internet, Internet protocol (IP), local-area network (LAN), optical networking, hybrid fiber coax (HFC), telephony, T1, or some other communication format-including combinations, improvements, or variations thereof. Wireless communication links can be a radio frequency, microwave, infrared, or other similar signal, and can use a suitable communication protocol as described herein. Communication link 106 can be a direct link or might include various equipment, intermediate components, systems, and networks. Communication links 106 may comprise many different signals sharing the same link.

Other network elements may be present in environment 100 to facilitate communication but are omitted for clarity, such as network functions, base stations, base station controllers, mobile switching centers, dispatch application processors, and location registers such as a home location register or visitor location register. Furthermore, other network elements that are omitted for clarity may be present to facilitate communication, such as additional processing nodes, routers, gateways, and physical and/or wireless data links for carrying data among the various network elements, e.g. between access node 110 and communication network 101.

Further, the methods, systems, devices, networks, network functions, access nodes, and equipment described above may be implemented with, contain, or be executed by one or more computer systems and/or processing nodes. The methods described above may also be stored on a non-transitory computer readable medium. Many of the elements of communication environment 100 may be, comprise, or include computers systems and/or processing nodes.

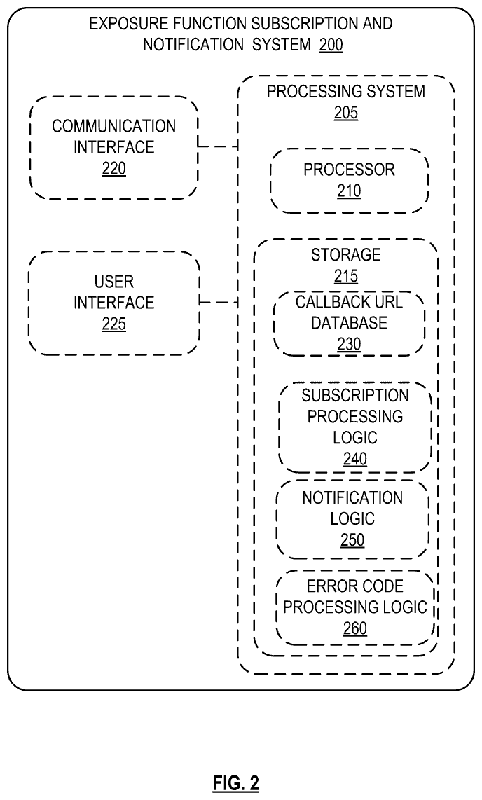

FIG. 2 illustrates an exposure function subscription and notification system 200 in accordance with embodiments described herein. The components described herein are merely exemplary as many different configurations for the exposure function subscription and notification system 200 may be implemented. The exposure function subscription and notification system 200 may be configured to perform the methods and operations disclosed herein to subscribe and notify AFs 160. In the disclosed embodiments, the exposure function subscription and notification system 200 may be integrated with the core network 102, for example with the NEF 150, (or an SCEF), or may be an entirely separate component capable of communicating with at least the NEF 150 of the core network 102 and the AF 160. Further, the components of the exposure function subscription and notification system 200 may be distributed so that one or more components are located within the NEF 150, SCEF, the AF160, and/or a separate processing node in communication with or integrated with the core network 102.

The exposure function subscription and notification system 200 may be configured for performing the operations described herein utilizing a processing system 205. Processing system 205 may include a processor 210 and a storage device 215. Storage device 215 may include a random access memory (RAM), read-only memory (ROM), disk drive, a flash drive, a memory, or other storage device configured to store data and/or computer readable instructions or codes (e.g., software). The computer executable instructions or codes may be accessed and executed by processor 210 to perform various methods disclosed herein. Software stored in storage device 215 may include computer programs, firmware, or other form of machine-readable instructions, including an operating system, utilities, drivers, network interfaces, applications, or other type of software. For example, software stored in storage device 215 may include a module for performing various operations described herein.

For example, subscription processing logic 240 may be operable to ensure that the AF 160 generates and/or transmits at least two callback URLs 164a . . . n in order to subscribe to the NEF 150. For example, the subscription processing logic 240 ensures that the AF 160 generates at least a primary callback URL and a secondary callback URL for transmission to the NEF 150. Further, the subscription processing logic 240 ensures that the NEF 150 receives and processes at least two callback URLs such as the primary and secondary callback URL.

Notification logic 250 is operable to trigger a notification from the NEF 150 to the AF 160 using one or more callback URLs. For example, the notification logic 250 may select a primary callback URL for providing a notification to the AF 160. The primary callback URL may correspond to a first server of the AF 160. The notification logic 250 may interact with error code processing logic 260. For example, upon failure to reach the AF160 through the primary callback URL, the error code processing logic 260 may cause generation of an error code to be detected. Upon detection of the error code, the error code processing logic 260 may interact with the notification logic 250 to trigger a notification to the secondary callback URL corresponding to a second callback server.

A callback URL database 230 may store callback URLs received in subscription requests to the NEF 150. As set forth herein, each subscription request may be associated with two or more callback URLs. Each of the multiple callback URLs correspond may correspond to an AF server in a different geographical location.

To perform the above-described operations, the subscription processing logic 240, the notification logic 250, and the error processing logic 260 may be executed by the processor 210 to manage subscription and notification processes between the NEF 150 and AFs 160 and to manage and update the callback URL database 230.

Processor 210 may be a microprocessor and may include hardware circuitry and/or embedded codes configured to retrieve and execute software stored in storage device 215. The exposure function subscription and notification system 200 further includes a communication interface 220 and a user interface 225. Communication interface 220 may be configured to enable the processing system 205 to communicate with other components, nodes, or devices in the wireless network.

Communication interface 220 may include hardware components, such as network communication ports, devices, routers, wires, antenna, transceivers, etc. User interface 225 may be configured to allow a user to provide input to the exposure function subscription and notification system 200 and receive data or information from other system components. User interface 225 may include hardware components, such as touch screens, buttons, displays, speakers, etc. The exposure function subscription and notification system 200 may further include other components such as a power management unit, a control interface unit, etc.

The location of the exposure function subscription and notification system 200 may depend upon the network architecture. As set forth above, the exposure function subscription and notification system 200 may be located in the core network 102, in a separate processing node, in the NEF 150, an SCEF, in multiple locations such as the NEF150, AF 160, and/or may be an entirely discrete component. Further, although shown as a single integrated system, the functions of exposure function subscription and notification system may be separated and be disposed in separate locations.

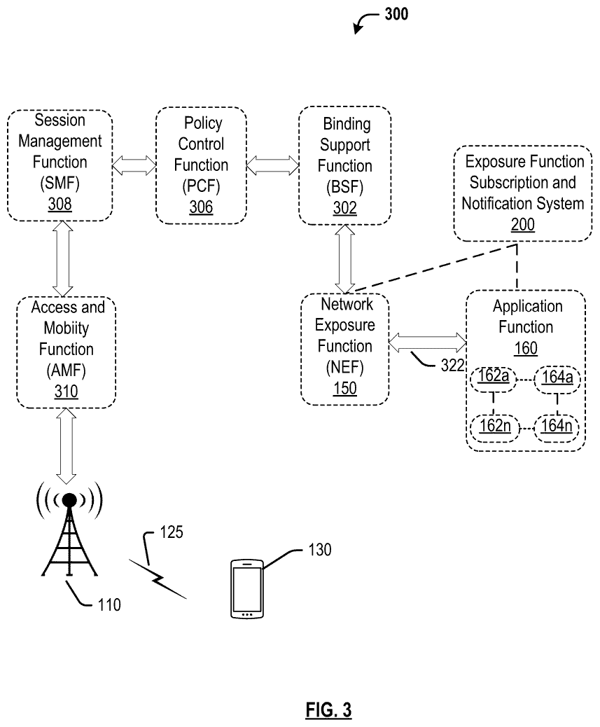

FIG. 3 depicts an environment 300 showing an exposure function subscription and notification system 200 operating within a network in a quality of service (QoS) use case. The AF 160 sits in the control plane and establishes QoS for subscribers to a service or application. A particular QoS may be required for the wireless device 130 connected over wireless link 125 to the access node 110. An access and mobility function 310 serves as the mobility entity, while a session management function (SMF) 308 controls sessions with the wireless device 130. The AMF 310 and the SMF 308 are packet control functions, which interact with the RAN 122 and/or the user plane functions 120.

Further, the SMF 308 communicates with a policy control function (PCF) 306. The PCF 306 communicates with a binding support function (BSF) 306 that is in direct communication with the NEF 150. As illustrated, the NEF 150 engages in subscription and notification processes over an N33 interface 322 with the AF 160. The AF 160 may include multiple servers 162a . . . 162n. Each of the servers 162a . . . 162n may have a corresponding callback URL 164a . . . 164n. The exposure function subscription and notification system 200 may communicate with or be incorporated in the NEF 150 and the AF 160.

In the illustrated embodiment, the AF 160 sends a subscription request to the NEF 150 including at least two callback URLs. For example, a primary callback URL 164a corresponds to server 162a and a secondary callback URL corresponds to server 162n. Upon occurrence of an event related to QoS, such as, for example, a bearer deletion, the PCF 306 notifies the NEF 150 through the BSF 302. In response, the exposure function subscription and notification system 200 may trigger generation of a notification from the NEF 150 to the AF 160 using a first or primary callback URL 164a corresponding to the server 162a. Should the notification be unsuccessful, the exposure function subscription and notification system 200 triggers a second notification from the NEF 150 to the secondary callback URL 164n corresponding to the server 162n. If additional callback URLs are provided with the subscription, upon failure with any previously attempted notification, the exposure function subscription and notification system 200 may trigger another notification from the NEF 150 to the AF 160 directed to another of the servers 162a . . . 162n corresponding to another provided callback URL 164a . . . 164n.

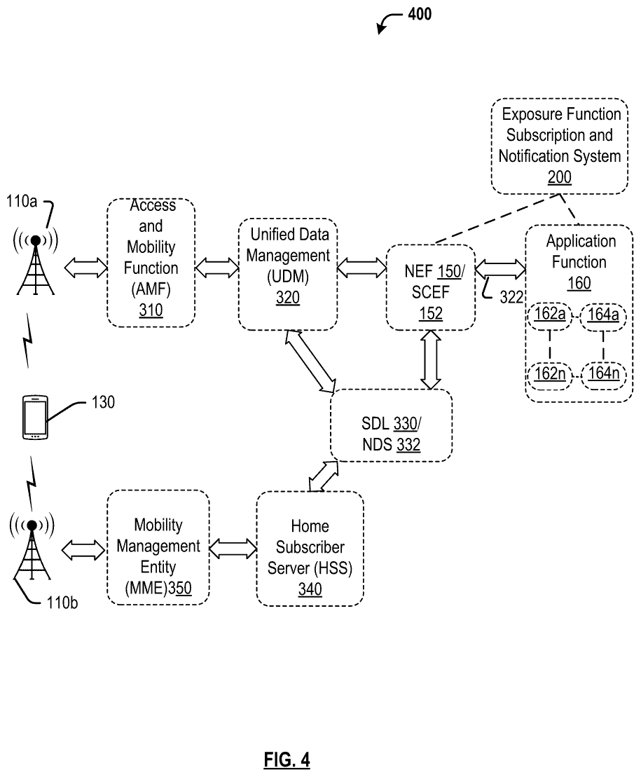

FIG. 4 depicts an environment 400 showing an exposure function subscription and notification system 200 operating within a network in a monitoring enhancement (MONTE) use case in both 4G LTE and 5G NR environments. A wireless device 130 connects over a 5G wireless link 125a to a gNB 110a. Alternatively, the wireless device 130 connects over a 4G LTE wireless link 125b with an eNB 110.

In the MONTE environment 400, the NEF 150 may monitor events related to the wireless device 130 and may make monitoring information available for external exposure. For example, the NEF 150 may monitor user location and services.

With respect to the 5G environment, as illustrated, the NEF 150 engages in subscription and notification processes 322 with the AF 160. As set forth with respect to FIG. 3, the AF 160 may include multiple servers 162a . . . 162n. Each of the servers 162a . . . 162n may have a corresponding callback URL 164a . . . 164n. The exposure function subscription and notification system 200 may communicate with or be incorporated in the NEF 150 and/or the AF 160.

In the illustrated embodiment, the AF 160 sends a subscription request to the NEF 150 including at least two callback URLs. For example, a primary callback URL 164a corresponds to server 162a and a secondary callback URL 164n corresponds to server 162n. In the 5G NR environment, The NEF 150 forwards the subscription to a unified data management (UDM) function 320, which forwards the subscription to the AMF 310. The UDM 320 may further interact with a shared data layer 330. The AMF 310 acknowledges the subscription by sending a message back to the UDM 320, which notifies the NEF 150 of the successful subscription.

With respect to notification, when the NEF 150 is notified of a MONTE event, it sends a notification to the AF 160 the using a first or primary callback URL 164a corresponding to the server 162a. Should the notification become unsuccessful, the exposure function subscription and notification system 200 triggers a second notification from the NEF 150 to the secondary callback URL 164n corresponding to the server 162n. Because additional callback URLs are provided with the subscription, upon failure with any previously attempted notification, the subscription and notification system 200 may trigger another notification from the NEF 150 to the AF 160 directed to another of the servers 162a . . . 162n corresponding to another provided callback URL 164a . . . 164n. The use of additional callback URLs for the AF 160 increases the probability that the AF 160 will receive the event notification.

In the 4G LTE environment, the NEF 150 may be replaced by an service capability exposure function (SCEF) 152, which is essentially a 4G LTE predecessor to the NEF. The SCEF 152 and AF 160 interact in the same manor as set forth above with respect to the NEF 150 and AF 160 in the 5G environment. Both the NEF 150 and SCEF 152 enable data to be transported within signaling messages via control plane.

Thus, in the 4G LTE environment, the subscription process between the SCEF 152 and AF 160 substantially parallels the process described above with respect to the NEF 150 and the AF 160 in the 5G NR environment. Further, the SCEF 152 forwards the subscription to the home subscriber server (HSS) 340 and the HSS 340 forwards the subscription to the mobility management entity (MME) 350. The HSS 340 may further interact with network directory system (NDS) 332. The MME 350 sends an acknowledgement back to the HSS 340. In response, the HSS 340 notifies the SCEF 152 of a successful subscription.

In the 4G LTE environment, upon occurrence of an event related to MONTE at the wireless device 130, the SCEF 152 receives an event trigger and sends a notification to the AF 160 using a first or primary callback URL 164a corresponding to the server 162a. Should the notification be unsuccessful, the exposure function subscription and notification system 200 triggers a second notification from the SCEF 152 to the secondary callback URL 164n corresponding to the server 162n. Because additional callback URLs are provided with the subscription, upon failure with any previously attempted notification, the subscription and notification system 200 may trigger another notification from the SCEF 152 to the AF 160 directed to another of the servers 162a . . . 162n corresponding to another provided callback URL 164a . . . 164n. The use of additional callback URLs for the AF 160 increases the probability that the AF 160 will receive the event notification.

All of the illustrated network functions can include a processor, a memory, and may be configured to perform the various functions described herein. Further, each network function can associate with different reference points, including reference points for data transmission between different network nodes and reference points for control signal transmission between different network nodes.

As illustrated, the exposure function subscription and notification system 200 may be incorporated in or communicate with the NEF150 or SCEF 152. Further, the exposure function subscription and notification system 200 may operate as a processing node in communication with the NEF 150, SCEF 152, and AFs 160 in order to trigger these network functions to perform the operations described herein.

All of the illustrated network functions can include a processor, a memory, and may be configured to perform the various functions described herein. Further, each network function can associate with different reference points, including reference points for data transmission between different network nodes and reference points for control signal transmission between different network nodes.

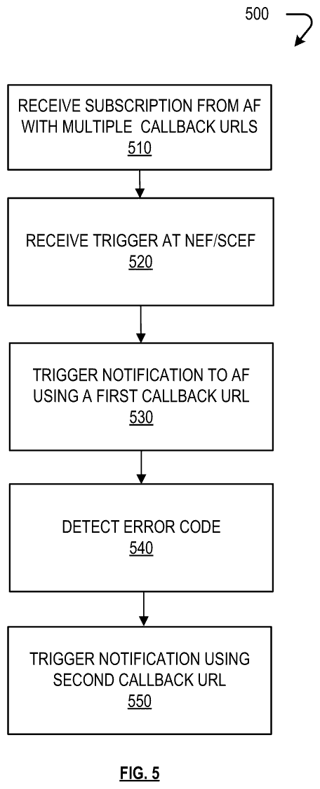

FIG. 5 depicts a further exemplary method 500 for subscription and notification in accordance with an embodiment. Method 500 may be performed by any suitable processor discussed herein, for example, the processor 210 included in the exposure function subscription and notification system 200 or in the NEF 150 or SCEF 152. For discussion purposes, as an example, method 500 is described as being performed by the processor 210 included in the exposure function subscription and notification system 200, which may be wholly or partially incorporated in the NEF 150, SCEF 152, and/or AF 160.

Method 500 starts in step 510, in which the processor 210 receives a subscription request sent from the AF 160 to the NEF 150 or SCEF 152. The subscription request includes multiple callback URLs. Each callback URL may correspond to a server of the AF 160. In step 520, an event trigger is detected as received at the NEF 150 or SCEF 152. The event trigger may be related to a QoS event or a MONTE event or any other type of event supported by the NEF 150 or SCEF 152.

In response to the event trigger, in step 530, the processor 210 triggers a notification from the NEF 150 or SCEF 152 to a first callback URL of the AF 160. The first callback URL may be considered a primary URL.

In response to the notification, the processor 210 may detect an error code in step 540. The error code may be transmitted, for example, when the AF server associated with the first callback URL is unavailable. Based on the detection of the error code in step 540, the processor 210 may trigger a further notification from the NEF 150 or SCEF 152 using a second callback URL in step 550. When an alternative AF server associated with the second callback URL is available, the notification process is completed.

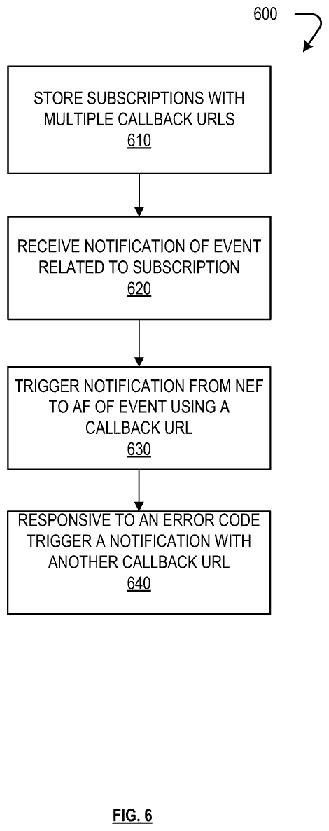

FIG. 6 depicts an additional exemplary method 600 for generating notifications from the NEF 150 or the SCEF 152. Method 600 may be performed by any suitable processor discussed herein, for example, the processor 210 in the exposure function subscription and notification system 200, which may be wholly or partially incorporated in the NEF 150 or SCEF 152. For discussion purposes, as an example, method 600 is described as being performed by the processor 210 included in the exposure function subscription and notification system 200.

In step 610, the processor 210 stores subscriptions of AFs 160, wherein each subscription includes multiple callback URLs. The AF subscriptions may be with the NEF 150 or the SCEF 152. The exposure function subscription and notification system 200 may store the subscriptions. Alternatively the NEF 150 or SCEF 152 may store the subscriptions. Other NFs may additionally or alternatively store the subscriptions.

In step 620, a notification of an event related to a stored subscription is received by the processor 210. The notification may be received, for example, by the NEF 150, SCEF 152, and/or subscription and notification system 200 from another NF and may be detected by the exposure function subscription and notification system 200.

Responsive to the received notification in step 620, the processor 210 triggers a notification of the event in step 630 from the NEF 150 or SCEF 152 to the AF 160 using a callback URL corresponding to an AF server. In step 640, responsive to an error code, the processor 210 triggers another notification to a different callback URL corresponding to a different AF server in step 640.

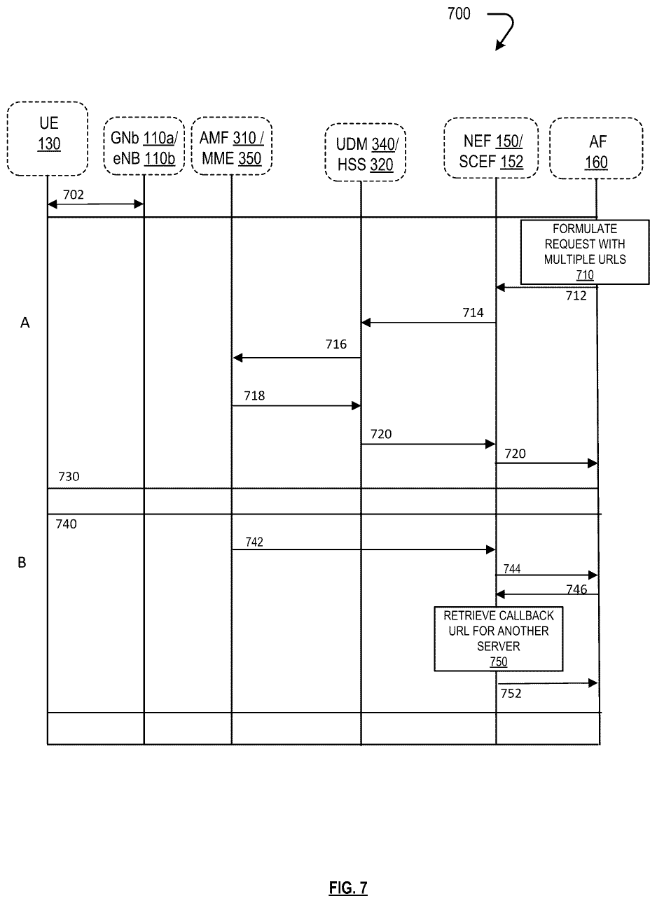

FIG. 7 illustrates a method 700 illustrating interaction between network functions during operation of the exposure function subscription and notification system 200 in accordance with an embodiment. As explained above, the exposure function subscription and notification system 200 may be a discrete node operating in conjunction with the NRF 150, SCEF 152, and/or AF 160. The exposure function subscription and notification system 200 may be partially or wholly incorporated in any of these components.

In step 702, the wireless device or UE 130 attaches to the network through interaction with a gNB 110a or an eNB 110b. Section A illustrates an exposure function subscription process in accordance with embodiments. In step 710, the AF 160 formulates a subscription request including multiple callback URLs to the NEF 150 or SCEF 152. In step 712, the AF 160 sends the subscription request to the NEF 150 or SCEF 152. In step 714, the request is posted to the UDM 320 or the HSS 340. The UDM 320 or HSS 340 transmits the request to the AMF 310 or MME 350 in step 716. In response, in step 718, the AMF 310 or MME 350 sends an acknowledgment such as a 201 created message indicating creation of the subscription to the UDM 320 or HSS 340. The UDM 320 or HSS 340 receives the acknowledgement and forwards a notification of successful subscription in step 720 to the NEF 150 or SCEF 142. Finally, the NEF 150 or SCEF 152 sends a notification that the subscription is created over a T8 or N33 interface to the AF 160. This completes creation of the subscription.

Section B illustrates an exposure function notification process in accordance with embodiments provided herein. In step 742, the NEF 150 or SCEF 152 receives an event trigger from an MME 350 or AMF 310. In response to the event trigger of step 742, the NEF 150 or SCEF 152 sends a notification to a first callback URL over a T8 or N33 interface in step 744. In some instances, the notification may be successful. However, in the illustrated scenario, the NEF 150, or SCEF 152 receives an error code indicating that the AF is not reachable through the first callback URL and thus the notification cannot be delivered. For example, the AF is not reachable due to security of a server associated with the first of the multiple callback URLs being compromised. Delivery of the notification is therefore prevented. Thus, in step 750, the NEF 150 or SCEF 152 retrieves another callback URL associated with another AF server. In step 752, the NEF 150 or SCEF 152 sends another notification to this secondary callback URL. In the illustrated embodiment, the AF 160 receives the notification. Accordingly, solutions provided herein ensure that the AF 160 receives the notification.

As set forth above, embodiments provide for subscription and notification between an AF 160 and NEF 150 or SCEF 152. In some embodiments, methods 300, 400, 500, 600, and 700 may include additional steps or operations. Furthermore, the methods may include steps shown in each of the other methods. Additionally, the order of steps shown is merely exemplary and the steps may be re-ordered as appropriate. As one of ordinary skill in the art would understand, the methods 300, 400, 500, 600, and 700 may be integrated in any useful manner.

The steps of the methods described above can be combined or rearranged in any meaningful manner. Further, the exemplary systems and methods described herein can be performed under the control of a processing system executing computer-readable codes embodied on a computer-readable recording medium or communication signals transmitted through a transitory medium. The computer-readable recording medium is any data storage device that can store data readable by a processing system, and includes both volatile and nonvolatile media, removable and non-removable media, and contemplates media readable by a database, a computer, and various other network devices.

Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid state storage devices. The computer-readable recording medium can also be distributed over network-coupled computer systems so that the computer-readable code is stored and executed in a distributed fashion. The communication signals transmitted through a transitory medium may include, for example, modulated signals transmitted through wired or wireless transmission paths.

Although the descriptions provided herein may be in the context of certain radio access technologies, networks, and network topologies, such as 5G/NR mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), Internet-of-Things (IoT), Narrow Band Internet of Things (NB-IoT), vehicle-to-everything (V2X), fixed wireless internet, and non-terrestrial network (NTN) communications. Thus, the scope of the disclosure is not limited to the examples described herein.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

1. A method comprising:
receiving at an exposure function a subscription request from an application function (AF), the subscription request including multiple callback uniform resource locators (URLs) associated with multiple servers;
receiving, at the exposure function, an event trigger associated with an event related to the subscription;
sending a notification from the exposure function to the AF of the event using a first of the multiple callback URLs;
receiving an error code in response to the notification; and
sending a notification from the exposure function to the AF using a second of the multiple callback URLs in response to receipt of the error code.

2. The method of claim 1 wherein each URL is associated with a server.

3. The method of claim 1, wherein the multiple callback URLs include two callback URLs.

4. The method of claim 1, wherein the AF is not reachable through the first of the multiple callback URLs such that delivery of the notification is prevented.

5. The method of claim 1, wherein the AF is reachable through the second of the multiple callback URLs and receives the notification.

6. The method of claim 1, wherein a notification to the exposure function is triggered by a mobility entity.

7. The method of claim 6, wherein the mobility entity is a mobility management entity (MME) or an access and mobility function (AMF).

8. The method of claim 1, wherein the exposure function is a network exposure function (NEF) or a service capability exposure function (SCEF).

9. A system comprising:
a memory storing data and instructions; and
a processor executing the stored instructions to perform operations including:
storing at an exposure function a subscription from an application function (AF), the subscription including multiple callback uniform resource locators (URLs) associated with multiple servers;
triggering a notification from the exposure function to the AF of an event, the notification using a first of the multiple URLs; and
responsive to an error code, sending a notification from the exposure function to the AF using a second of the multiple URLs.

10. The system of claim 9, wherein each URL is associated with a server.

11. The system of claim 9, wherein the multiple callback URLs include two callback URLs.

12. The system of claim 9, wherein the AF is not reachable through the first of the multiple callback URLs such that delivery of the notification is prevented.

13. The system of claim 12, wherein the AF is not reachable due to security of a server associated with the first of the multiple callback URLs being compromised.

14. The system of claim 9, wherein the AF is reachable through the second of the multiple callback URLs and receives the notification.

15. The system of claim 9, wherein each of the multiple callback URLs corresponds to an AF server in a different geographical location.

16. The system of claim 9, wherein a notification to the exposure function is triggered by a mobility entity.

17. The system of claim 16, wherein the mobility entity is a mobility management entity (MME) or an access and mobility function (AMF).

18. A non-transitory computer-readable medium storing instructions executed by a processor to perform operations including:
triggering a notification from an exposure function to an application function (AF) having a subscription to services offered through the exposure function, the notification using a first of multiple callback URLs corresponding to the subscription; and
responsive to an error code, triggering a notification from the exposure function to the AF using a second of the multiple callback URLs.

19. The non-transitory computer-readable medium of claim 18, wherein the AF is not reachable through a first of the multiple callback URLs such that delivery of the notification is prevented.

20. The non-transitory computer-readable medium of claim 18, wherein the AF is reachable through the second of the multiple callback URLs and receives the notification.
